(19) United States
(12) Patent Application Publication
(10) Pub. No.: US 2002/0142809 A1
(43) Pub. Date: Oct. 3, 2002

(54) One key dialed digital wireless telephone

(75) Inventors: Young S. Kim, Los Altos, CA (US); Antonio L. Indindoli, Gilroy, CA (US)

Correspondence Address: FLEHR HOHBACH TEST ALBRITTON & HERBERT LLP, Suite 3400, Four Embarcadero Center, San Francisco, CA, 94111-4187, US

(73) Assignee: Young S. Kim, Palo Alto, CA

(21) Appl. No.: 10/085,463

(22) Filed: Feb. 26, 2002

Related U.S. Application Data
(60) Provisional application No. 60/272,231, filed on Feb. 27, 2001.

(51) Int. Cl. H04B 1/38

(52) U.S. Cl. 455/566; 455/90; 455/550

(57) ABSTRACT

A wireless telephone is described in which dialing is performed by manipulating a single key or button.

### RELATED APPLICATIONS

This application claims priority to provisional application Serial No. 60/272,231 filed Feb. 27, 2001.

### BRIEF DESCRIPTION OF THE INVENTION

This invention relates generally to a one key or button dialed digital wireless telephone and more particularly to a digital telephone in which numbers, letters and other functions are selected by manipulating a single key or button.

### BACKGROUND OF THE INVENTION

Conventional telephone dialing systems for telephones employ a plurality of keys disposed as a keypad for selecting numbers, letters or other functions. Such telephones also include a variety of other keys for sending and ending messages, clearing entries, recalling stored telephone numbers and many other functions that are included in various types of telephones. In general, the telephones are operated by holding them in one hand and manipulating the keys with the fingers of the other hand. As devices have become smaller, they have been held in the fingers of one hand and operated with the thumb of the same hand. However, as the devices are miniaturized, it becomes increasingly difficult to locate and depress selected keys. There is a need for devices that can be easily dialed while held in one hand.

### OBJECTS AND SUMMARY OF THE INVENTION

It is a general object of the present invention to provide a simple, easily manipulated dialing system for wireless digital telephones.

It is another object of the present invention to provide a dialing system in which a single key or button is moved for dialing or selecting numbers, letters or other functions (herein referred to as “symbols”).

The foregoing and other objects of the invention are achieved by a dialing system for wireless telephones in which a single key or button is moved and then depressed to select and place in memory one symbol at a time.

### BRIEF DESCRIPTION OF THE DRAWINGS

The invention will be clearly understood from the following description when read in conjunction with the accompanying drawings in which:

FIG. 1 is a plan view of a wireless digital telephone in accordance with one embodiment of the present invention.

FIG. 2 is a perspective sectional view showing the dial key or button mechanism of FIG. 1 cooperating with a printed circuit board, which guides the key to select numbers, letters or other functions.

FIG. 3 is an enlarged view of the printed circuit board showing a groove and associated key plunger.

FIG. 4 is a plan view of the printed circuit board illustrating the layout of the grooves for a conventional telephone keypad.

FIG. 5 is a plan view of another embodiment of a wireless telephone in the dialing mode.

FIG. 6 is a plan view of a wireless telephone having an electronic one key or button control in the menu mode of operation.

FIG. 7 is a plan view of a wireless telephone having an electronic one key or button control.

### DESCRIPTION OF THE PREFERRED EMBODIMENT OF THE INVENTION

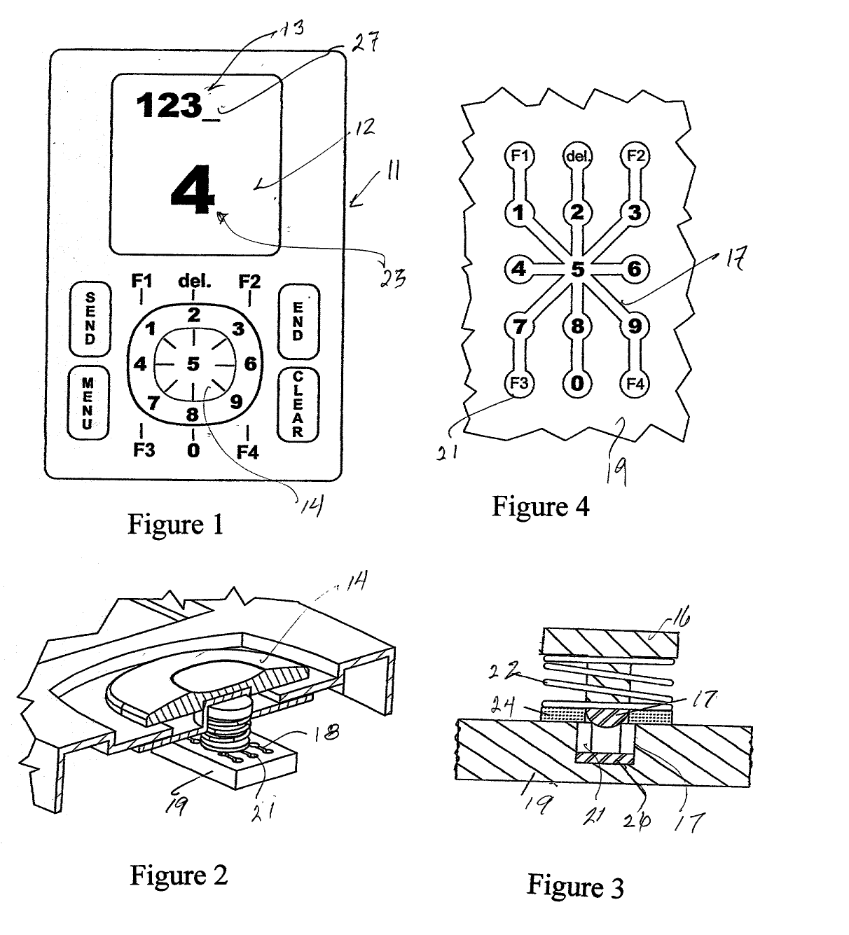

A wireless telephone 11 is schematically shown in FIG. 1. The telephone includes a display area 12 where telephone numbers and other information sent and received by the telephone are displayed and a display area 13 where numbers, letters and other selected symbols are viewed. In accordance with the present invention, a single key or button 14 is moved to select the numbers, letters and functions. Referring to FIGS. 2, 3 and 4, the key engages the cap 16 of plunger 17, the end of which can slide along the top of groove 18 formed in a printed circuit board 19. The channels include wells 21 sized to accommodate the plunger 17. The plunger is spring-loaded, spring 22, so that it rides along and is guided by the top of the channels. When it reaches a well corresponding to the desired symbol, the symbol is displayed in the display area 23 and the key is then depressed, moving the plunger 17 into the corresponding well 21. An electrical circuit between the sliding contact 24 and the printed circuit board contact 26 is completed through the plunger to select the symbol that is displayed. Referring to FIG. 1, the numbers 1, 2 and 3 were previously selected and displayed. The number 4 has been selected and, upon depression of the key, it will be recorded at the location 27. The electronic circuits and controls for the wireless digital telephone are well within the ability of those skilled in the art and are not further discussed. It is seen that there has been provided a simple mechanical key which is guided for movement to select with one key the numbers, letters and symbols which are usually selected by individual keys. The dialing can be easily carried out with a single finger, preferably the thumb, while the telephone is held in the fingers of the same hand.

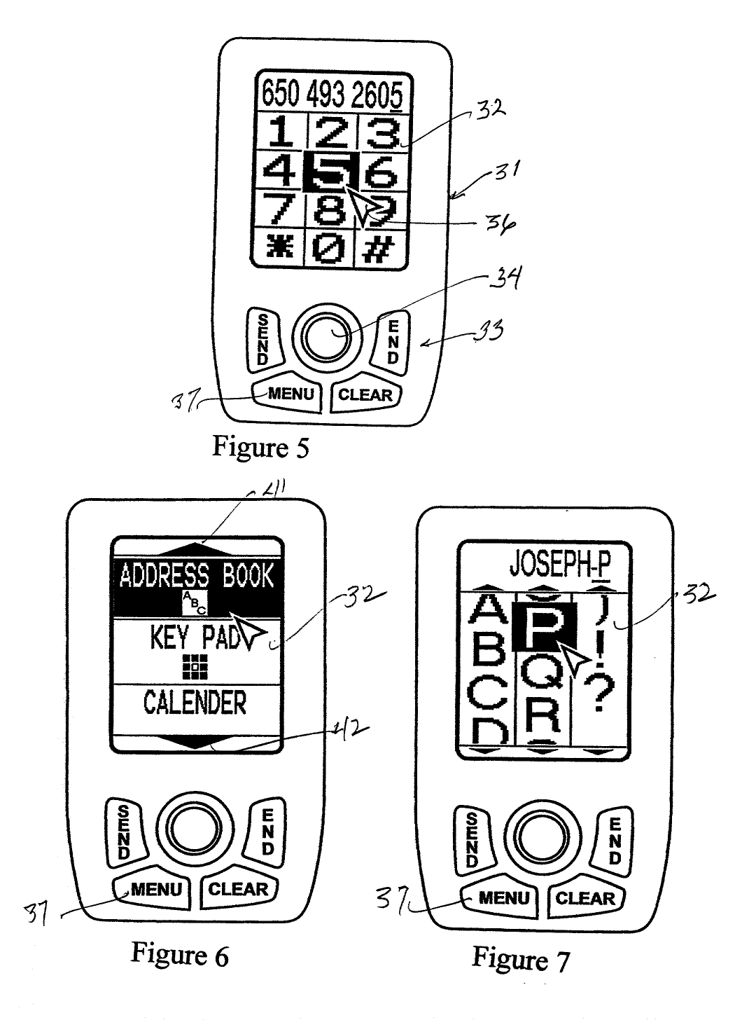

In a second embodiment of the single key dialed digital wireless telephone is shown in FIG. 5. The wireless telephone 31 includes a screen 32 and controls 33. The controls include a one-button control in the form of a joystick or track ball 34, which controls an on-screen cursor 36. Depressing the menu key 37 displays a telephone keypad.

In FIG. 5, the number 650 493 2601 was and entered. The last selected number 5 is highlighted and shown underlined in the telephone number. If the number 5 is the correct number, the user depresses the button and the number is then registered. Thus, again, there is provided one key dialing.

The single button system can be used to carry out other operating functions of wireless telephones by selecting the menu function and scrolling.

Referring to FIG. 6, for example, the menu button 37 can be depressed to provide a display of the functions which can be selected. By bringing the cursor to one of the arrows 41 or 42, the menu (functions) are scrolled to select a particular display, for example, the keypad of FIG. 5 for dialing the telephone. A communication mode can be selected wherein the letters of the alphabet and numbers are displayed. The user can enter words or numbers into the telephone for transmission. In FIG. 7, the user has already selected and entered the first name (JOSEPH) of a person. He has selected the first letter of the last name, P, which also appears next to the first name at the top of the display area. If this is the correct letter, the button is depressed to enter the letter and the cursor moved to select the next letter, etc.

Of particular importance is the ability of the user to dial telephone numbers and to compose messages using a single key or button.

What is claimed is:

1. A wireless telephone including:
a display area and a keypad area,
said keypad area including one button which is movable to display selected numbers, letters or functions and depressed to record the selected number, letter or function for dialing or transmission.

2. A wireless telephone as in claim 1 in which the one button is moved along and guided to number, letter or function locations by channels.

3. A wireless telephone as in claim 2 in which the channels include wells located at positions corresponding to a particular number, letter or function.

4. A wireless telephone as in claim 3 in which the number is recorded by depressing the plunger into the well corresponding to the selected number, letter or function.

5. A wireless telephone as in claim 1 in which the button is a joystick or trackball which is moved to select, and depressed to send, the selected number, letter or function.

6. A wireless telephone including:
a display area,
a one button control for selecting numbers, letters or symbols,
means for displaying selected numbers, letters or symbols in the display area,
means controlled by depression of said button for recording the displayed selected number, letter or symbol, and
means for displaying all of the selected numbers, letters or symbols.

7. A wireless telephone as in claim 6 including channels and wells formed in a printed circuit board, said wells being located at number, letter or symbol locations, a plunger associated with said control button adapted to slide along the channels to a selected well location, and means associated with said plunger serving to complete an electrical circuit when the plunger is depressed into a selected well to record the particular number, letter or symbol associated with said well.
